(19) United States
(12) Patent Application Publication
(10) Pub. No.: US 2017/0180642 A1
(43) Pub. Date: Jun. 22, 2017

(54) MOBILE COMMUNICATION DEVICE WITH DOCUMENT IMAGING FACILITY AND METHOD

(71) Applicant: Bennet K. Langlotz, Dallas, TX (US)

(72) Inventor: Bennet K. Langlotz, Dallas, TX (US)

(21) Appl. No.: 14/971,004

(22) Filed: Dec. 16, 2015

(51) Int. Cl. H04N 5/232

(52) U.S. Cl. CPC H04N 5/23245

(57) ABSTRACT

An imaging device has an imager or camera defining an optical axis and operable to generate an image. The device includes an orientation sensor operable to detect the orientation of the body with respect to a frame of reference such as vertical, and to generate an orientation signal based on the detected orientation. A processor has a number of image modification modes and is operable to receive the image and to modify the image based on the image modification mode. The processor is connected to the orientation sensor and operates to select an image modification mode based on the orientation signal.

### BACKGROUND OF THE INVENTION

As smartphones and other mobile communication devices become ubiquitous, and fax machines and dedicated document scanners are uncommon in many homes and offices, smart phones have become a popular tool for transmitting images of printed documents. While many documents may be shared via email in original electronic formats such as .doc and .pdf, many times users need to transmit images of documents that are in hard copies. This may include documents requiring original signatures, receipts for rebates, forms to authorize charges, and the like.

Existing smartphones have cameras that can take images of documents that may then be transmitted by email or text message like any photo. However, photos of documents are less than ideal. They tend to be poorly exposed (showing grey background instead of white), poorly lit (showing unwanted colors due to white balance errors), and poorly cropped (showing background items that may also compromise privacy or professionalism).

These image limitations may be adequate for limited purposes, but for some purposes, such as reprinting without ink or toner waste, professional presentability, readability, efficient document storage and transmission, and other applications, they suffer from disadvantages.

Some smartphones have cameras with various imaging modes, including a document mode. This provides improved exposure providing better contrast between the typical black text on white background. While providing improved benefits, this feature may be inconvenient to manually access and select, and many users are unaware of its existence and the problems associated with imaging documents using the camera.

Therefore, there is a need for a mobile communication device that overcomes these limitations of existing devices by providing an imaging device having an imager or camera defining an optical axis and operable to generate an image. The device includes an orientation sensor operable to detect the orientation of the body with respect to a frame of reference such as vertical, and to generate an orientation signal based on the detected orientation. A processor has a number of image modification modes and is operable to receive the image and to modify the image based on the image modification mode. The processor is connected to the orientation sensor and operates to select an image modification mode based on the orientation signal.

### BRIEF DESCRIPTION OF THE DRAWINGS

FIGS. 1 and 2 are schematic side views of a device according to a preferred embodiment of the invention.

### DESCRIPTION OF THE CURRENT EMBODIMENT

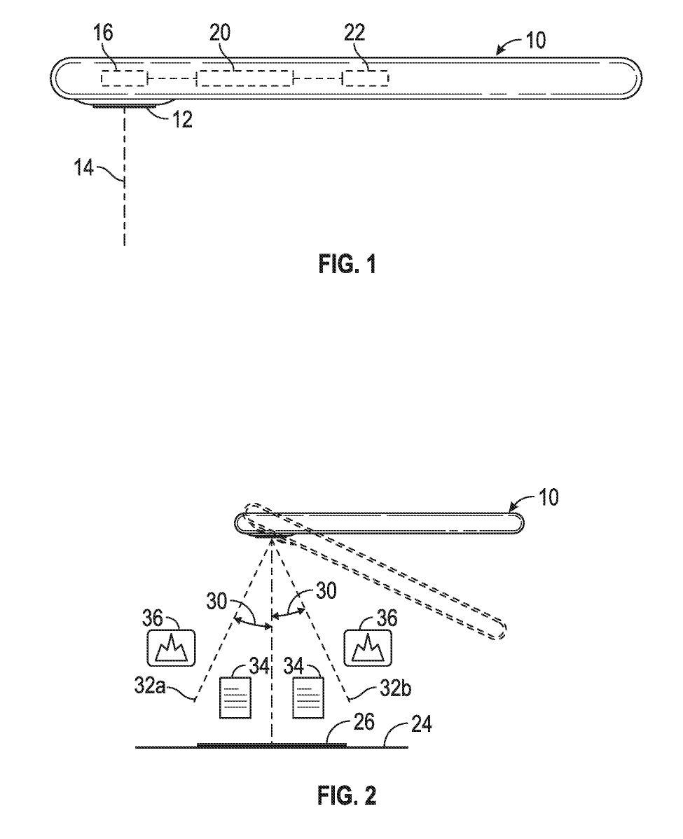

FIG. 1 shows a smart phone or mobile device 10 that includes a camera lens 12 defining an optical axis 14. In alternative embodiments, the device 10 may be any camera, tablet, watch, component or other device having the facilities described herein, or working with other devices in a system having these facilities. The capabilities are expressed in terms of current devices, but it is recognized that in the near future there may be very different devices with imaging capabilities in which these concepts may be expressed.

The device 10 includes circuitry having numerous functionalities. These may be provided in separate components as may be shown schematically, or on one or more larger circuits, in software, or in remote devices that operate cooperatively with the device. An image sensor 16 is optically aligned with the lens 12. A processor 20 is connected to the image sensor to receive an image signal or data packet containing an image from the image sensor 16. In some embodiments the sensor may be part of a common circuit or component as the processor.

The device circuitry also includes an orientation sensor 22 that is connected to the processor, and which may be part of common circuitry. The sensor operates to detect the orientation of the device with respect to the force of gravity. It may be an array of accelerometers that detect acceleration in several axes, in order to determine a direction acceleration. While an orientation sensor may be capable of detecting motion or acceleration of the device, for these purposes, it serves to determine the orientation of the device with respect to gravity. For devices having only a two-axis sensor or other limited sensing capabilities use for screen rotation, they may be employed in a manner such that the lack of a positive signal in either orientation would indicate a flatter orientation, so that a positive screen rotate signal in either the X or Y axes (both perpendicular to the optical Z axis 14) would indicate a normal imaging condition, while the lack of such signals would indicate a document imagine condition.

FIG. 2 shows the camera or smartphone 10 in the horizontal orientation with the optical axis 14 vertical, and perpendicular to a horizontal surface 24 upon which a flat document 26 rests. A threshold offset angle 30 is indicated, and threshold optical axis limit lines 32a, 32b are indicated symmetrically on either side of the vertical optical axis 14. The threshold lines are offset from vertical by the threshold offset angle 30.

The range of angles between the threshold lines 32a, 32b represents the document imaging mode, and is indicated by document icons 34. Outside of this limited angular range in which the camera is facing straight down or only a limited deviation from vertically downward is the standard imaging zone, indicated by scenic mountain icons 36.

In the preferred embodiment, the offset angle 30 may be established by consumer research to determine the typical habits of users attempting to image documents on a horizontal surface, so that users do not need to be needlessly precise to trigger the document mode, but so that users taking pictures of a subject well below camera level (such as a crawling baby) do not have the document mode unwantedly triggered. The threshold angle or sensitivity may be adjusted to suit the needs of the user, and operation may be selected to default to certain mode, or to prompt the user to select a suggested mode (e.g. “Do you wish to image this in document mode?”)

When a user desires to capture an image of a document, typically for electronic transmission, he has different imaging needs than a user seeking simply to take a photo. While a mode that takes realistic photos of people and scenery may be effective for those subjects, it is often a poor choice for documents. Most documents are white, flat rectangular objects having text arranged in lines, typically printed in black. They are well-captured and transmitted by fax machines with limited spatial resolution, and color resolution of simply one pit per pixel (black or white). When conventional cameras take a picture of a paper document in normal room lighting, they tend to expose the document to generate a gray average tone, making the white background needlessly dark. This reduces contrast, making the document less legible, and wasting toner or ink upon reprinting.

Cameras also tend to create unwanted color in a document image. They also may have different aspect ratios than the documents, creating margins beyond the document that reveal the surface that supports the document. This may have a color or value that affects the exposure, and may have other disadvantages. With some light sources, the image illumination may be uneven. A point source close to the image, such as the camera flash or a desk lamp may create a brightness gradient or hotspot. Other light sources may create uneven lighting. These factors may be challenging to adjust after the fact with simple exposure compensation or adjustment of image curves to the entire image.

Careful framing may eliminate some or all of the background, but normally this is a challenge. Similarly, orienting the document in the image without tile is difficult, and getting the camera image plane parallel to the image is difficult, with errors resulting in keystoning or skew. Existing cameras may have means to correct some of these after the fact.

Even when a captured image is adequate for transmission, cameras will typically save a photo in a convention image format such as jpeg. This introduces image compression artifacts that impair document readability. Documents are typically desired in other formats such as pdf, and tiff (the format of fax machines), as well as text formats such as txt, rtf, and doc, if they have been processed with optical character recognition (OCR).

In the preferred embodiment, the camera or device 10 recognizes that the image may be a document, and sets the image processing mode to document mode using processing techniques to address and fix the above issues. Recognition in the preferred embodiment occurs when the processor detects that the camera is point straight down, or within a limited deviation from vertically downward.

The recognition process may include analysis of the image, including detection of a rectangular object on a different background, a white subject, the presence of parallel lines that may be text, and extensive flat areas. The recognition process may occur after an image is taken, and the prompts given afterward. The image may be processed as a document automatically without user intervention or prompting, and the original image file retained or restorable.

For devices lacking an orientation sensor, the determination of whether a document is being imaged may be made by analysis of the image alone, detecting the above characteristics, or comparing the image against a database of typical document images for common characteristics that distinguish them from other non-document images.

Other embodiments may employ prompting at any stage, including at the point of emailing or other transmission of a document. However, there are benefits of avoiding needless prompting and user decision, which provides an advantage to the orientation sensor generating a default assumption about whether a document is being imaged.

In alternative embodiments, the device may simply store orientation information within or along with the image file, and this may be transmitted to a recipient to aid the recipients viewing or printing device or software to determine the appropriate type of processing needed to generate the desired image.

In other alternative embodiments, the relative orientation of the camera to the document may be established by means other than orientation with respect to gravity and the assumption that a document would normally rest on a horizontal surface. This may include the use of distance sensors such as sonar to establish that a flat object perpendicularly faces the camera. Or the camera focus facility may detect that a broad object filling a large portion of the field of view has all of its area at nearly the same distance, or with distances that yield a planar object with the closest point near the middle.

I claim:

1. An imaging device comprising:
a device body;
an imager connected to the body;
the imager defining an optical axis;
the imager operable to generate an image;
an orientation sensor connected the body;
the orientation sensor operable detect the orientation of the body with respect to a frame of reference;
the orientation sensor being operable to generate an orientation signal based on the detected orientation;
a processor in the body and connected to the imager;
the processor having a plurality of image modification modes;
the processor being operable to receive the image and to modify the image based on the image modification mode;
the processor being connected to the orientation sensor; and
the processor being operable to select an image modification mode based on the orientation signal.

2. The device of claim 1 wherein the frame of reference is gravity.

3. The device of claim 1 wherein the frame of reference is a plane associated with a surface of an object in the field of view of the imager.

4. The device of claim 1 wherein the image modification mode is selected from a plurality of image modification modes including a photo mode providing realistic image rendering and a document mode.

5. The device of claim 4 wherein the processor in the document mode is operable to provide a modification including at least one of exposure adjustment, cropping, deskewing, color balancing, and format conversion.

6. The device of claim 1 wherein the processor is operable to select a document mode based the optical axis being determined to be within a limited angle from vertical.

7. The device of claim 1 wherein the processor is operable to prompt the user to accept the selected image modification mode.

8. A camera comprising:
a lens operable to generate an image;
a sensor operable to detect the orientation of the lens; and
a processor operable to process the image based on the orientation.

9. The camera of claim 8 wherein the processor processes the image in a document mode when the lens is pointed downward.

10. The camera of claim 9 wherein the processor processes the image in a document mode when the lens is pointed within a selected limited angle of vertical.

11. The camera of claim 10 wherein the limited angle is less than 20 degrees.

12. The camera of claim 8 wherein the sensor is operable to detect orientation of the camera with respect to gravity.

13. The camera of claim 8 wherein the processor has a plurality of processing modes including a standard imaging mode operable to generate a photographic rendering of the image, and a document mode operable to generate enhanced readability of an imaged document.

14. The camera of claim 8 wherein the processor is operable when the orientation is within selected limited parameters to provide a document enhancement to the image.

15. The camera of claim 14 wherein the processor when providing document enhancement is operable to provide modifications including at least one of exposure adjustment, cropping, deskewing, color balancing, and format conversion.

16. The camera of claim 14 wherein the document enhancement includes detecting a document background and adjusting the background to a selected white level.

17. A method of operating a camera comprising the steps:
determining the orientation of the camera with respect to a subject;
capturing an image of the subject;
based on the orientation, selecting an imagining mode; and
based on the imaging mode, processing the image.

18. The method of claim 17 wherein determining the orientation includes determining the orientation of the camera with respect to vertical.

19. The method of claim 17 wherein determining the orientation includes determining the angular orientation of the camera with respect to a subject plane defined by a planar subject.

20. The method of claim 19 including detecting whether the subject is a planar subject.
